(19) United States
(12) Patent Application Publication
(10) Pub. No.: US 2012/0160823 A1
(43) Pub. Date: Jun. 28, 2012

(54) HEATING APPARATUS

(76) Inventors: Donald William BRYCE, Natick, MA (US); Wing Sun (Felix) Wong, Ashland, MA (US); Robert Scott Ashworth, Littleton, MA (US)

(21) Appl. No.: 13/286,305

(22) Filed: Nov. 1, 2011

Related U.S. Application Data
(60) Provisional application No. 61/427,640, filed on Dec. 28, 2010.
(60) Provisional application No. 61/436,767, filed on Jan. 27, 2011.

(51) Int. Cl. H05B 3/06

(52) U.S. Cl. 219/508; 219/541

(57) ABSTRACT

Several embodiments of an electric heater are disclosed, each of which includes a master or a satellite heating unit and a slave or a base heating unit. The base or slave unit selectably derives heating power and heating control either from the master or satellite unit through a disconnectable electrical cord or derives heating power and heating control independently there-from. The master or satellite and slave or base units are adapted for tool-free mechanical attachment and separation. A communicating arrangement distinguishes between the attachment and the separation and alters the heating power and control according thereto by causing transfer of at least some of the heating control of the slave or base unit from the slave or base unit to the master or satellite unit during the attachment.

### RELATED APPLICATIONS

This application is a Continuation-in-Part of U.S. Provisional Application Ser. No. 61/427,640 filed on Dec. 28, 2010 and U.S. Provisional Application Ser. No. 61/436,767 filed on Jan. 27, 2011, the entire teachings of which are hereby incorporated herein by reference.

### FIELD OF THE INVENTION

The present invention is generally related to household heaters, and more specifically to portable electric heaters for providing heat to one or more portions of a home or room.

### BACKGROUND OF THE INVENTION

There is an ongoing need to obtain localized heating at home and in the work place. Portable electric heaters have become a common tool for providing heat to a portion of a home or room, to thereby avoid the expense and inefficiencies associated with heating an entire home. As energy costs rise and incomes fall in a declining economy, the need to obtain maximum comfort from each BTU of heat produced by such heaters is ever more important. Homes occupied by only one or two persons, or homes in which only one or two rooms are typically occupied, are particularly vulnerable to the wasted energy and expense of heating an entire home.

Certain electrical air heaters include the ability to direct heat toward one person and thereby minimize the waste of energy heating elsewhere when only one person is present. The Radiant Air Heater disclosed in U.S. Pat. No. 1,614,230, and numerous similar heaters since, employs a parabolic reflector to direct heat waves from the heating element into a narrow beam so that the energy produced by the element can be focused towards a single user. However, such heaters are not capable of providing heat to multiple users or to multiple portions of a user's body simultaneously, at differing heating powers and temperatures.

Certain electrical air heaters include the ability to direct heat toward two separated persons and thereby minimize the waste of energy heating elsewhere when only two persons is present. The Pivotable Heater disclosed in U.S. Pat. No. 6,321,034, and numerous similar heaters since, includes two heating units sharing a common pivot axis which may be directed independently so that one heating unit aims its heat output at a first user and the other heating unit aims its heat output at a second user. However, such heaters are not capable of providing heat to multiple users or to multiple portions of a user's body simultaneously, at differing heating powers and temperatures.

Certain electrical air heating systems include the ability to emit heat into two different locations within a room. The System for Obtaining a Uniform Air Temperature in a Discrete Space disclosed in U.S. Pat. No. 6,624,394 includes two heaters that communicate with each other so that each operates at a power level according to the power level and temperature sensed by the other to most effectively heat the entire room. The heaters may be disposed in different locations within the room and cooperate to obtain and maintain a balanced temperature level throughout the room. The heaters are physically connectable together for storage. However, such a system is not capable of continuously operating its two heating units at differing heating powers and temperatures. Additionally, such a system is not capable of simultaneously providing heat at differing heating powers and temperatures within the same location in the room such as to multiple portions of a single user's body, since the sensed temperature by both heaters would be at least approximately identical. Also, both heaters would constantly operate approximately identically when disposed approximately together within the same location in room, regardless of the direction in which each heater's output was being aimed, so that different power levels and temperatures could not be aimed towards different parts of the room when the two heating units were disposed approximately together.

Certain electrical air heaters include the ability to provide heat to two different portions of a room or direct heat toward two different directions at different power levels and temperatures. The Portable Electric Space Heater disclosed in U.S. Pat. No. 6,466,737 includes a heater comprising two physically separable heating units that either each supply half of the heater's heat energy under a single control and may be separated and operated independently in different locations under independent control and power. However, no means are taught to allow one unit to sense its attachment to the other nor to control the operation of the other in only the attached state, either under identical operating parameters or under differing ones.

There exists the need for an air heating appliance which is capable of selectively providing heat to either one user, multiple users, or to multiple portions of a user's body simultaneously, at differing heating powers and temperatures, and such is an object of the present invention.

There exists the need for an air heating appliance which is capable of simultaneously providing heat at differing heating powers and temperatures within the same location in the room, such as to multiple portions of a single user's body, and such is an object of the present invention.

There exists the need for an air heating appliance having two or more separable heating units in which one unit is able to sense its attachment to the other and to control the operation of the other in only the attached state, either under identical operating parameters or under differing ones, and such is an object of the invention.

There exists the need for an air heating appliance having two or more separable heating units electrically connectable together by one or more detachable cords, such that each cord may be detached and snaked through tight spaces and reconnected, to connect the heating units through the tight spaces, and such is an object of the invention.

Other needs and objects will become apparent upon a reading of the following disclosure in combination with the appended drawings.

### SUMMARY OF THE INVENTION

The invention may be embodied in an electric heater having a plurality of heating units which are selectively adaptable to operate as a single heater, as two separable and dependently operable heating units, or as two separable and independently operable heating units.

The electric heater may include a base heating unit and one or more satellite heating units which are separably attachable to the base heating unit, and which may either derive their power and control from the base unit or may derive their power and control independently there-from.

The electric heater may include a master heating unit and one or more slave heating units which are separably attachable to the master heating unit, and which may either derive their power and control from the master unit or may derive their power and control independently there-from.

The electric heater may include a base heating unit and one or more satellite heating units which are separably attachable to the base heating unit, and the base heating unit may either derive its power and control from one of the satellite units or may derive its power and control independently there-from.

The invention may be embodied as an electric heater having a master heating unit and a slave heating unit, wherein the slave heating unit derives heating power and heating control from the master unit through a disconnectable electrical cord. One of the master and slave units may comprise a connector, and the other of the master and slave units may comprise the disconnectable cord, and the disconnectable cord may be adapted to electrically and mechanically connect to and disconnect from the connector. The connector may be a non NEMA 1 or NEMA 5 outlet. The master and slave units may be adapted for tool-free mechanical attachment and separation.

The invention may first-alternatively be embodied as an electric heater having a satellite heating unit and a base heating unit, wherein the base unit derives heating power and heating control from the satellite unit through a disconnectable electrical cord. One of the satellite and base units may comprise a connector, and the other of the satellite and base units may comprise the disconnectable cord, and the disconnectable cord may be adapted to electrically and mechanically connect to and disconnect from the connector. The connector may be a non NEMA 1 or NEMA 5 outlet. The master and slave units may be adapted for tool-free mechanical attachment and separation.

The invention may second-alternatively be embodied as an electric heater having a satellite heating unit and a base heating unit, wherein the base unit selectably derives heating power and heating control either from the satellite unit through a disconnectable electrical cord or derives heating power and heating control independently there-from. One of the satellite and base units may comprise a connector, and the other of the satellite and base units may comprise the disconnectable cord, and the disconnectable cord may be adapted to electrically and mechanically connect to and disconnect from the connector. The disconnectable cord may be adapted to selectably connect to a NEMA 1 or NEMA 5 outlet to derive heating power independently there-from when disconnected from the connector. The master and slave units may be adapted for tool-free mechanical attachment and separation.

A communicator may distinguish between the attachment and the separation of the satellite and base units and alter the heating power and control according thereto. The communicator may cause transfer of at least some of the heating control of the base unit from the base unit to the satellite unit during the attachment of the satellite and base units. The communicator may comprise one or more of a mechanical switch and an electronic photo-coupler.

The invention may third-alternatively be embodied as an electric heater having a master heating unit and a slave heating unit, wherein the slave unit selectably derives heating power and heating control either from the master unit through a disconnectable electrical cord or derives heating power and heating control independently there-from. One of the master and slave units may comprise a connector, and the other of the master and slave units may comprise the disconnectable cord, and the disconnectable cord may be adapted to electrically and mechanically connect to and disconnect from the connector. The disconnectable cord may be adapted to selectably connect to a NEMA 1 or NEMA 5 outlet to derive heating power there-from when disconnected from the connector. The master and slave units may be adapted for tool-free mechanical attachment and separation.

A communicator may distinguish between the attachment and the separation of the master and slave units and alter the heating power and control according thereto. The communicator may cause transfer of at least some of the heating control of the slave unit from the slave unit to the master unit during the attachment of the master and slave units. The communicator may comprise one or more of a mechanical switch and an electronic photo-coupler.

Further features and aspects of the invention are disclosed with more specificity in the Detailed Description and Drawings of an exemplary embodiment provided herein.

### BRIEF DESCRIPTION OF THE DRAWINGS

Many aspects of the invention can be better understood with reference to the following drawings showing the representative embodiment of the accompanying Detailed Description. The components in the drawings are not necessarily to scale, emphasis instead being placed upon clearly illustrating the principles of the invention. Moreover, in the drawings, like reference numerals designate corresponding parts throughout the several views.

FIG. 1 is a perspective view of a portable electric heater in accordance with a first exemplary embodiment of the invention with its slave-satellite heating unit attached to its master-base heating unit;

FIG. 2 is a perspective view of the heater of FIG. 1 with its slave-satellite heating unit attached to its master-base heating unit, and tilted upwardly relative thereto;

FIG. 3 is a rear view of the heater of FIG. 1;

FIG. 4 is a perspective view of the heater of FIG. 1 with the slave-satellite unit removed for the master-base unit and positioned remotely there-from;

FIG. 5 is a partial perspective view of the heater of FIG. 4 showing the interconnection of the master-base and slave-satellite units;

FIG. 6 is a partial close-up perspective view of the heater of FIG. 1 with the housing of the slave-satellite unit removed;

FIG. 7 is a partial close-up perspective view of the heater of FIG. 1 as configured in FIG. 2 with the housing of the slave-satellite unit removed;

FIG. 8 is a partial cross-sectional close-up view of the interconnection of the slave-satellite and master-base units of the heater of FIG. 1;

FIG. 9 is a perspective view of a portable electric heater in accordance with a second exemplary embodiment of the invention with its master-satellite heating unit attached to its slave-base heating unit;

FIG. 10 is a rear view of the heater of FIG. 9;

FIG. 11 is a side view of the heater of FIG. 9 with its master-satellite unit being removed from its slave-base unit;

FIG. 12 is a perspective view of the heater of FIG. 9 with the master-satellite unit removed from the slave-base unit and positioned remotely there-from;

FIG. 13 is a side view of the heater of FIG. 9 with its master-satellite unit being reattached to its slave-base unit;

FIG. 14 is a partial cross-sectional view of the heater of FIG. 9 at the forward portion of the interface of the master-satellite and slave-base units;

FIG. 15 is a partial cross-sectional view of the heater of FIG. 9 at the rearward portion of the interface of the master-satellite and slave-base units;

FIG. 16 is an upward perspective view of the master-satellite unit of the heater of FIG. 9;

FIG. 17 is a top view of the slave-base unit of the heater of FIG. 9;

FIG. 18 us a partial rear view of the satellite unit of the heater of FIG. 9;

FIG. 19 is a perspective view of a portable electric heater in accordance with a third exemplary embodiment of the invention with its master-satellite heating unit attached to its slave-base heating unit;

FIG. 20 is a rear view of the heater of FIG. 19;

FIG. 21 is a perspective view of the heater of FIG. 19 with the master-satellite unit removed for the slave-base unit and positioned remotely there-from;

FIG. 22 is a partial top view of the master-satellite unit of the heater of FIG. 19;

FIG. 23 is a diagram of the electronic circuitry of the master-satellite unit of the heater of FIG. 9; and

FIG. 24 is a diagram of the electronic circuitry of the slave-base of the heater of FIG. 9.

### DETAILED DESCRIPTION OF SEVERAL REPRESENTATIVE EMBODIMENTS

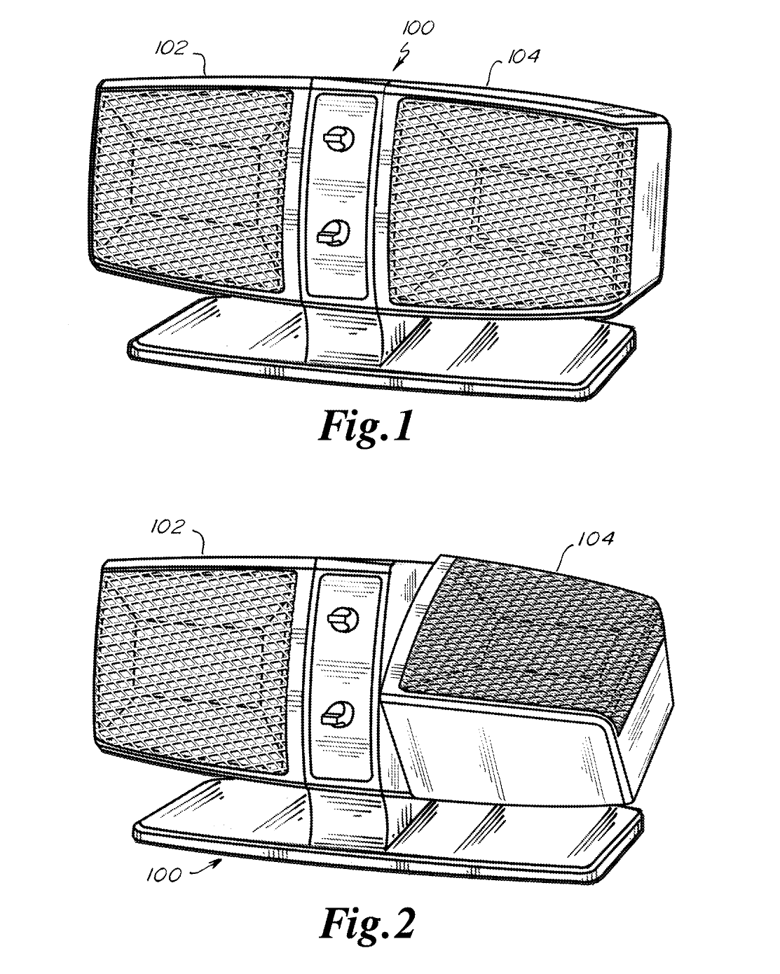

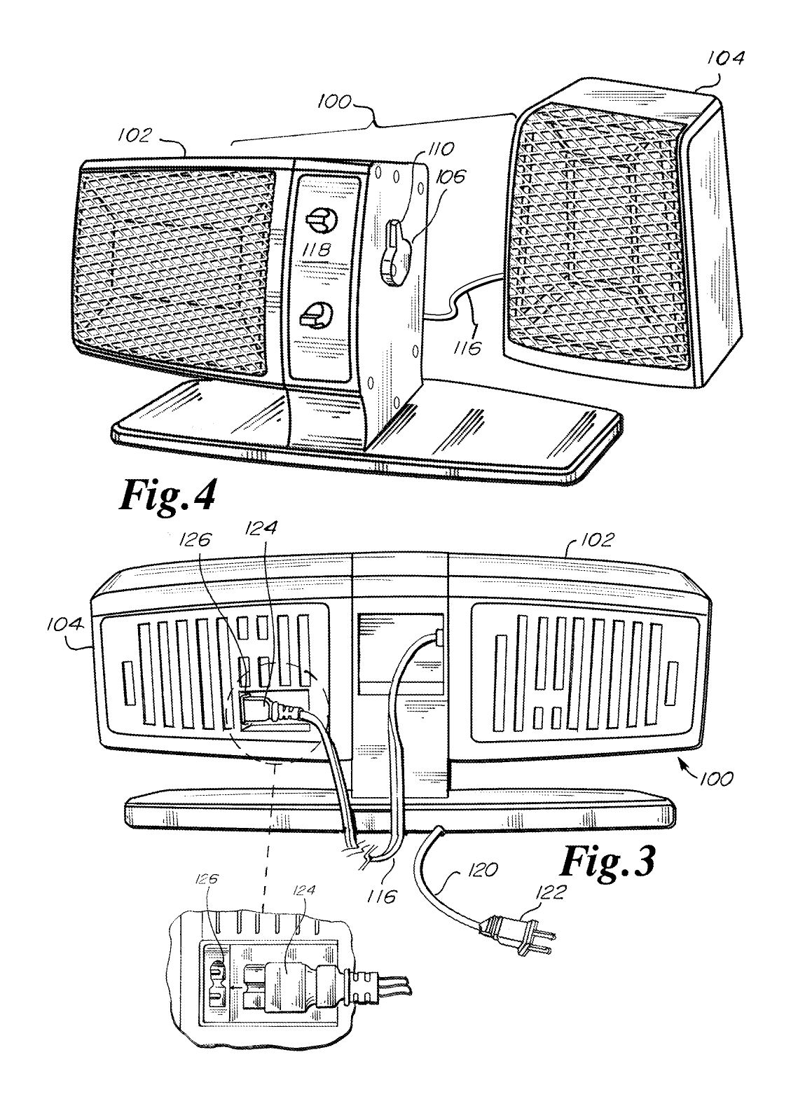

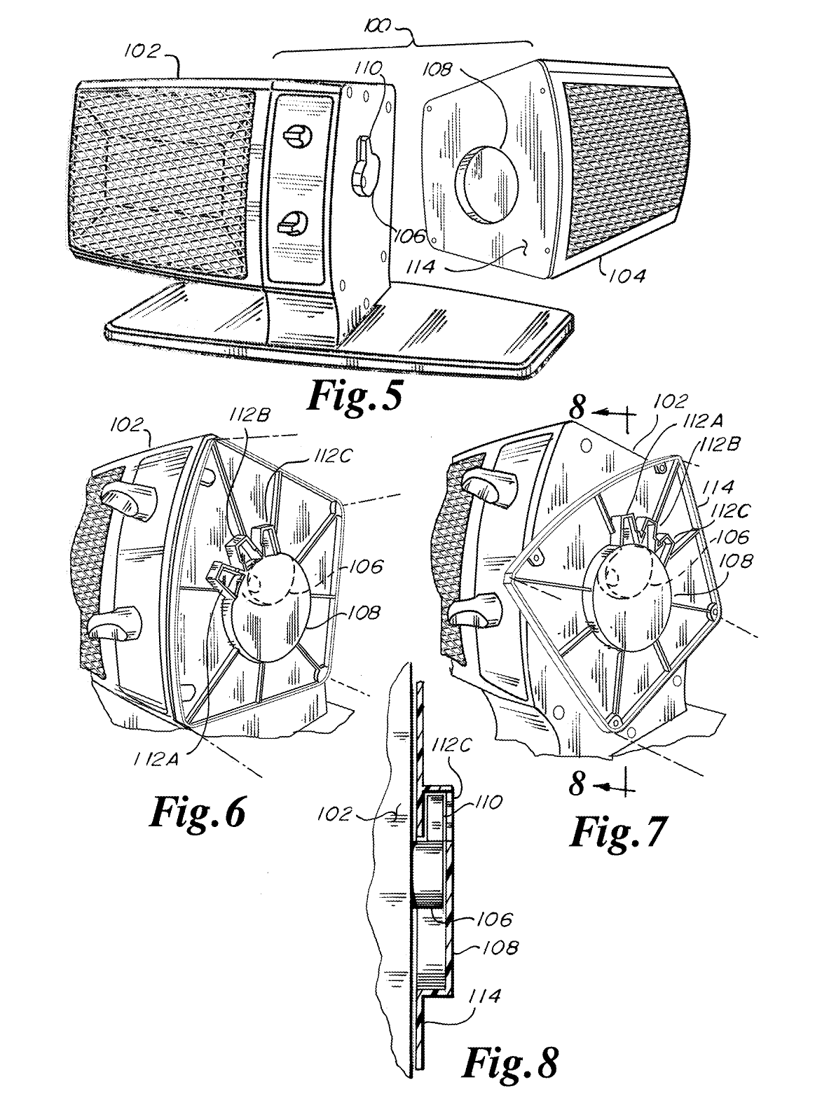

Referring to FIGS. 1 through 8, a portable air heater 100 according to a first example of the invention is shown, which includes a master-base unit 102 and a slave-satellite unit 104. The slave-satellite unit is mechanically attachable to and removable from the master-base unit at post 106 of the master-base and pocket 108 in bottom panel 114 of the slave-satellite. Key 110 of post 106 engages one of three key-slots 112A to 112 C of pocket 108 to allow the slave-satellite to be tilted relative to the master-base in any of three positions, which can be appreciated by comparison of the relatives position shown in FIG. 1 versus that shown in FIG. 2. As seen in FIGS. 4 and 5, the slave-satellite may be mechanically removed completely from the master-base and set down remotely from it, electrically connectable thereto by disconnectable cord 116.

While the disclosed heating units each employ fan-forced radiant heating elements to provide heat by passing ambient air through a blower over an energized heating element, any practical traditional form of electrical heating system may be alternatively employed.

Master-base unit 102 includes thermostatic and power controls 118 for managing the temperature and power output, respectively, of both the master-base and slave-satellite units, when the two are electrically connected through cord 116, or of just the master-base unit, when they are disconnected. A/C cord 120, is connectable to a standard NEMA 1 or NEMA 5 wall outlet by its NEMA 1 plug 122, to supply power to the master-base unit. The master-base unit may thus be operated alone as any traditional electrical heater, or may operated together with the slave-satellite unit through the disconnectable cord as any traditional electrical heater.

Disconnectable cord 116 includes a non NEMA 1 or NEMA 5 plug, in this case a polarized IEC320C7 plug 124, which is not connectable to a NEMA 1 or NEMA 5 wall outlet. Slave-satellite unit 104 has an IEC320C7 outlet 126 to disconnectably receive this plug to allow the satellite-slave until to receive its power through the master-base unit 102. This safety feature prevents improper connection of the slave-satellite unit directly to a wall outlet and forces proper operation and control of the slave-satellite unit only through the master-base unit.

The disconnectability of cord 116 provides, among others, the advantage of allowing the cord to be snaked through tight spaces and reconnected so that the two heating units can be connected and operated across such tight spaces. For instance, the master-base unit may be placed within the kneehole of a desk that is almost up against a wall, and the slave-satellite unit may be placed atop the desk, and disconnected cord 116 may be passed through the narrow gap between he desk and the wall, then reconnected to allow operation of the two units in such an arrangement without needing to move the desk. As many computer tables and entertainment centers have allowance for electrical cable routing through narrow channels nowadays, this feature can me more than a convenience. It can provide the only practical way to operate the master-base and slave-satellite unit across such channels.

Depending on the length of cord 116, the slave-satellite unit may be placed and operated remotely from the master-base unit and at a distance capable of serving two users or two portions of a room. The disclosed cord 116 is preferably six feet in length to allow operational separation of the heating unit approximately six feet. A male-to-female IEC320C7 extension cord may be employed to extend this separation distance. The disclosed heater 100 provides that when the two heating units are connected through the disconnectable cord, the controls 118 control operation of both heating units identically, with both operating at identical power outputs and operating only when the thermostat of the master-base unit is closed, thereby only and always both operating when the ambient temperature is below the selected thermostat setting. However, the slave-satellite unit may alternatively have a second and independent thermostat that allows it to operate according to a different ambient temperature sensed at its remote location.

A/C electrical heaters are power consumption limited by law, typically to 1500 Watts. While each of the heating units of the disclosed heater draw 750 Watts at all times operating, the master-base unit could alternatively include means to sense electrical disconnection of the slave-satellite unit and to increase its power to 1500 Watts when operating alone.

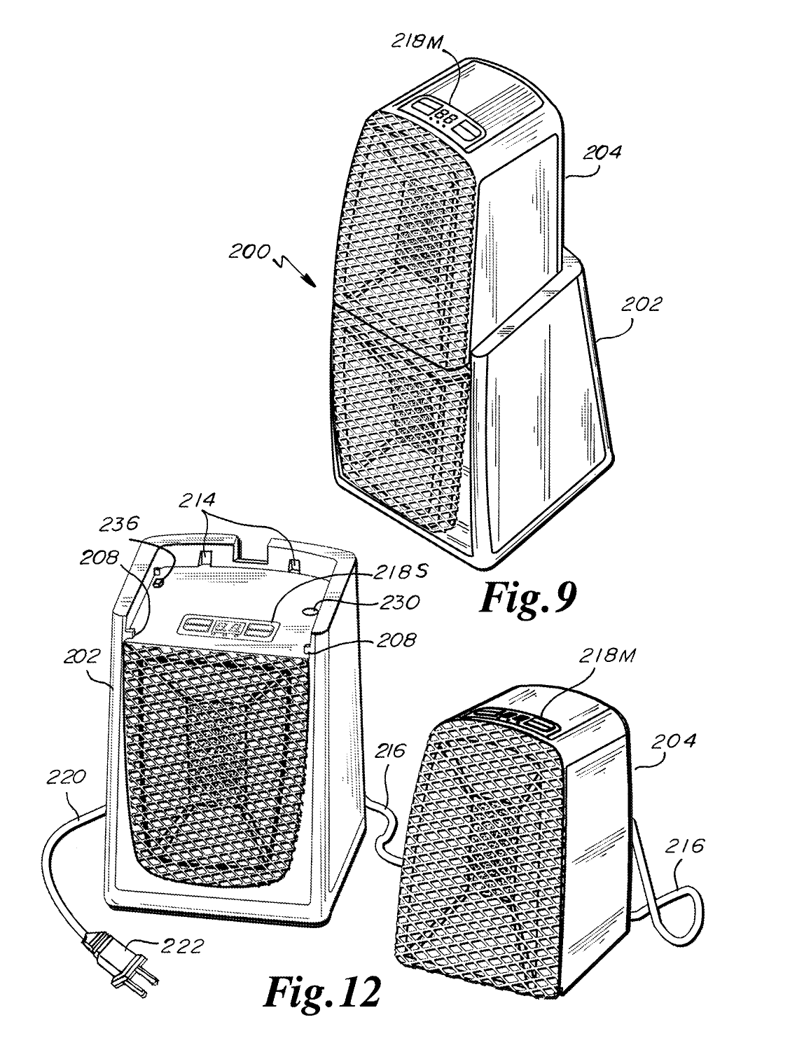

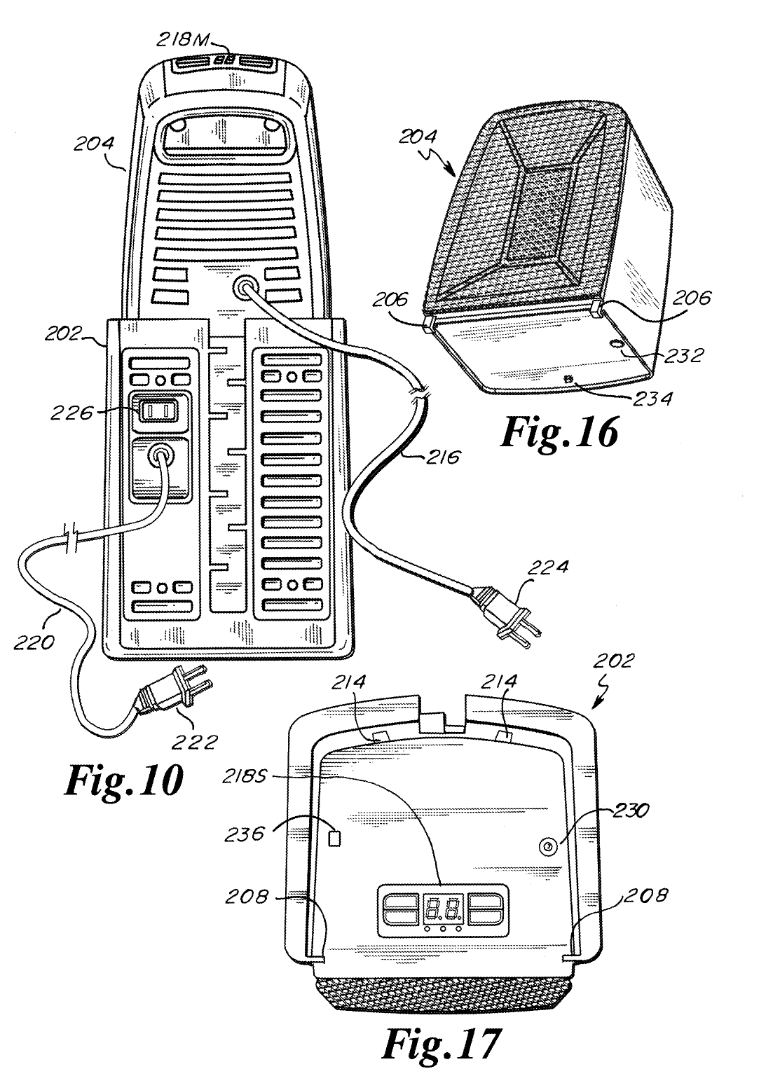

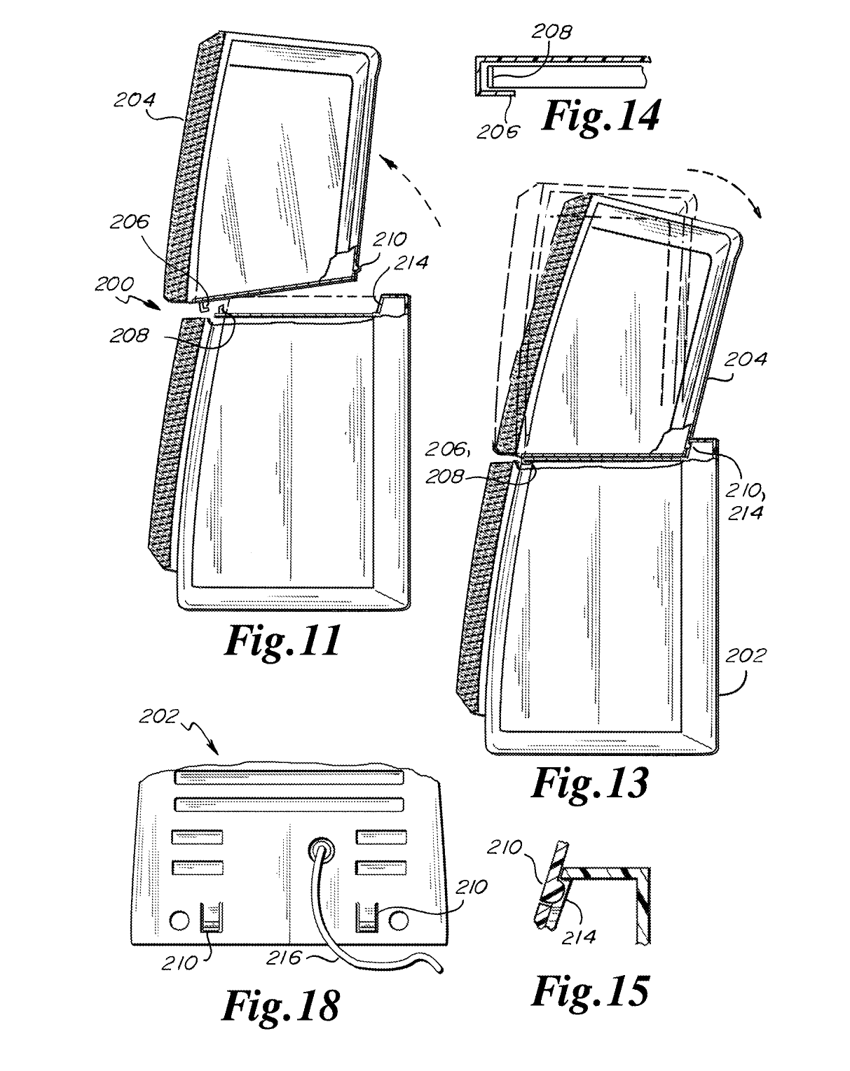

Referring next to FIGS. 9 through 18, a portable air heater 200 according to a second example of the invention is shown, which includes a slave-base unit 202 and a master-satellite unit 204. The master-satellite unit is mechanically attachable atop and removable from the slave-base unit by connections of hooks 206 and spring tabs 210 of the master-satellite unit to tabs 208 and holes 214 of the slave-base unit, respectively, as seen best in FIGS. 14 and 15. As seen in FIGS. 11 and 12, the master-satellite unit may be mechanically detached from the slave-base unit and set down remotely from it, electrically connectable thereto by disconnectable cord 216. As seen in FIG. 13, the master-satellite unit may be reattached atop the slave-base unit by hooking hooks 206 over tabs 208 and swinging the maser-satellite unit back-side downwardly until spring tabs 210 engage holes 214.

Both master-satellite unit 204 and slave-base unit 202 include digital thermostatic and power controls 218M and 218S, respectively, for independently managing the temperature and power output of each unit when the units are separated. Means are provided for communication between the two heating units in the form of an electronic photo-coupler and a pair of switches which are activated when the heating units are attached. Infrared receiver 230 atop the slave-base unit aligns with infrared emitter 232 on the underside of the master-satellite unit when the two are properly physically coupled, and micro-switch 234 on the underside of the master-satellite unit and microswitch 236 on the top of the slave-base unit are each depressed by the other unit when the two units are attached together to at least partially disable the slave-base unit's electronic control system and partially override it with the master-satellite's control system when the two units are properly electrically and physically connected, The infrared emitter is illuminated by the master-satellite control whenever the slave-base should operate, and the infrared receiver detects the illumination of the infrared emitter at those times and causes operation of the slave-base unit. This ensures that the two heating units are synchronized and cooperative. During such attachment and cooperative operation, disconnectable cord 216 connects the two units and power to the master-satellite unit is derived through the slave-base unit's series-connected A/C cord 220 and A/C outlet 226.

When the two heating units are physically disconnected the digital electronic controls of each unit independently control the operations of each unit. A/C cord 220, is connectable to a standard NEMA 1 or NEMA 5 wall outlet by its NEMA 1 plug 222, to supply power to the slave-base unit and series-connected NEMA-1 or NEMA-5 A/C outlet 226. The slave-base unit may thus be operated alone as any traditional electrical heater, or may operated together with the master-satellite unit through the disconnectable cord as any traditional electrical heater.

Disconnectable cord 216 of the master-satellite unit also includes a NEMA 1 or NEMA 5 plug 224, which is also connectable to a standard NEMA 1 or NEMA 5 wall outlet (preferably when the units are remotely separated), or to the slave-bases' A/C outlet 226 (preferably when the units are near to each other or attached).

The disconnectability of cord 216 provides, among others, the advantage of allowing the cord to be snaked through tight spaces and reconnected so that the two heating units can be connected and operated across such tight spaces, as explained in regards to the previous embodiment.

Because both heating units are equipped with their own NEMA A/C cords they may each perform as a completely independent heater, even when they are distantly separated. The master-satellite unit may be placed and operated remotely from the slave-base unit and at a distance capable of serving two users or two portions of a room, or may even be operated in different rooms of a house, or in different houses.

The disclosed heater 200 provides that when the two heating units are connected, the master-satellite controls 218M control operation of both heating units identically, with both operating at identical power outputs and operating only when the thermostat of the slave-base unit is closed, thereby only and always both operating when the ambient temperature is below the selected thermostat setting. However, when separated, the slave-base unit's thermostat and controls operate independently according to its selected power setting and a different ambient temperature sensed at its remote location.

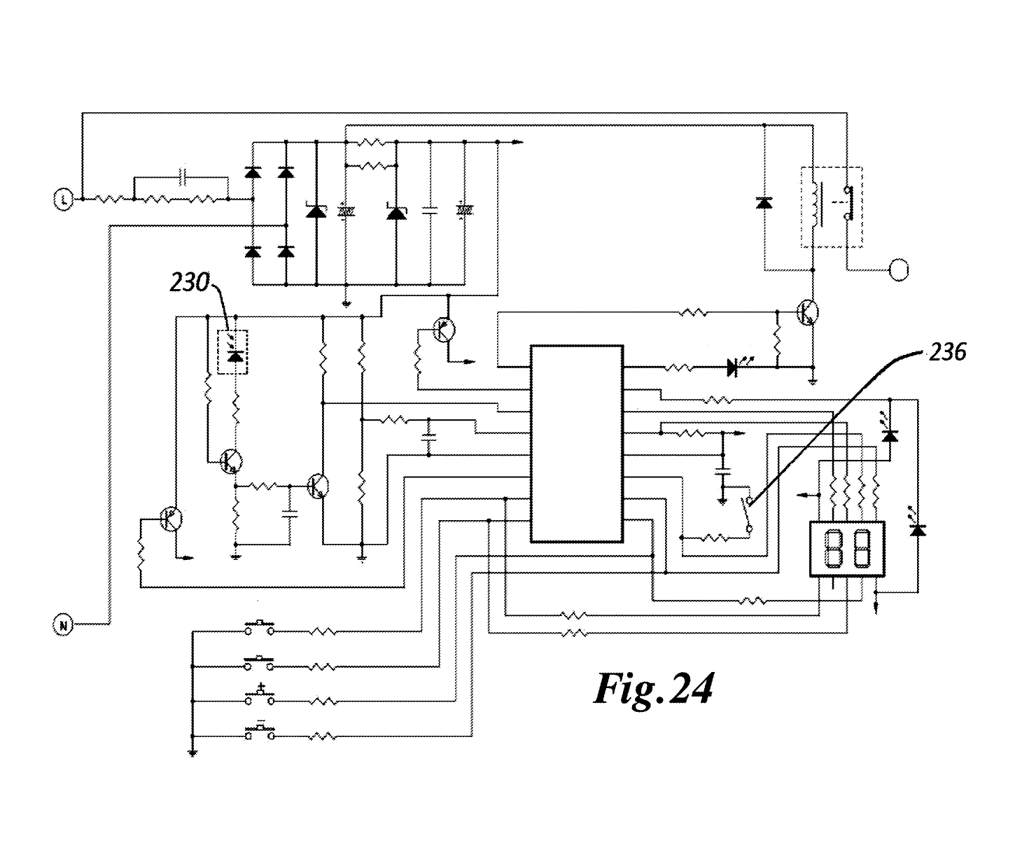

As seen in FIGS. 23 and 24, each of the master-satellite unit and a slave-base unit of heater 200 has its own electronic circuitry of the control of heat output and temperature; that of the master-satellite unit shown in FIG. 23 and that of the slave-base unit shown in FIG. 24. When separated, both units function as individual heaters, each under its own electronic-control. When the master-satellite unit is properly stacked upon the top of the slave-base unit, heat and temperature control of the combined unit will be carried out by the electronic-control in the master-satellite unit, while the electronic-control in the slave-base unit is caused to “hibernate”.

Referring to FIG. 23, the master-satellite unit's circuitry is shown, which includes the aforementioned micro-switch 234, and an infrared emitter 232, both physically disposed on the bottom side of the master-satellite unit as shown in FIG. 16. FIG. 24 shows the circuitry of the slave-base-unit, which includes micro-switch 236 and infrared receiver 230, both physically disposed on the top side of the slave-base unit as shown in FIG. 12. When the master-satellite unit and slave-base unit are separated, micro switches 234 and 236 are opened, infrared emitter 232 and infrared receiver 230 are shut off and there is no interaction between them. Both units thus operate independently.

When the master-satellite unit is engaged atop the slave-base unit, as shown in FIG. 9, micro-switches 234 and 236 are depressed into their closed-positions, and the infrared emitter 232 and receiver 230 are aligned together. When micro-switch 236 of the slave-base unit is closed, it shuts off the LCD display and key-pad function in the electronic circuit of FIG. 24, and turns on the infrared receiver 230 in the slave-base unit to await signaling from the infrared emitter 232 of the master-satellite unit. When micro-switch 234 of the master-satellite unit closed, it turns on the infrared emitter 232 to interact with the infrared receiver 230 of the slave-base unit. Infrared emitter 232 sends signals to infrared receiver 230 to control the heat and temperature setting in the slave-base unit. This results in control of the heat output power and temperature control of the combined unit solely by the master-satellite unit.

As earlier stated, A/C electrical heaters are power consumption limited by law, typically to 1500 Watts. While each of the heating units of the disclosed heater draw 750 Watts at all times operating, the communicating means allow that the two heating units may each have maximum power ratings of 1500 W and operate as independent 1500 W heaters when disconnected, and automatically reduce maximum power to 750 W each when connected.

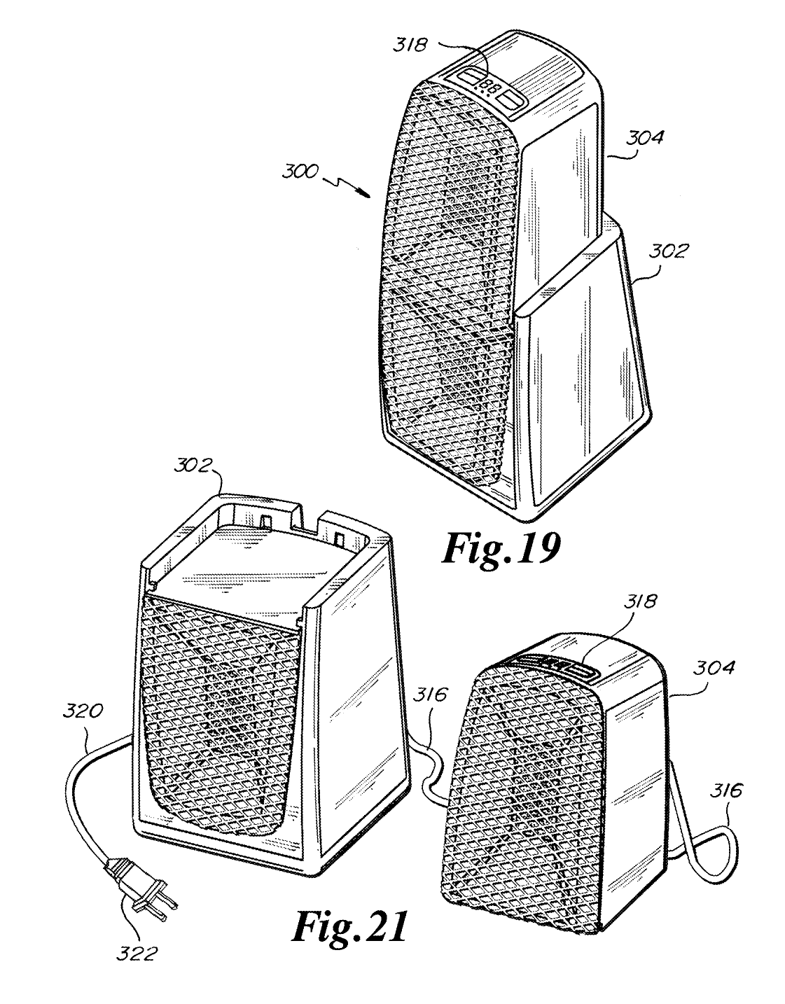

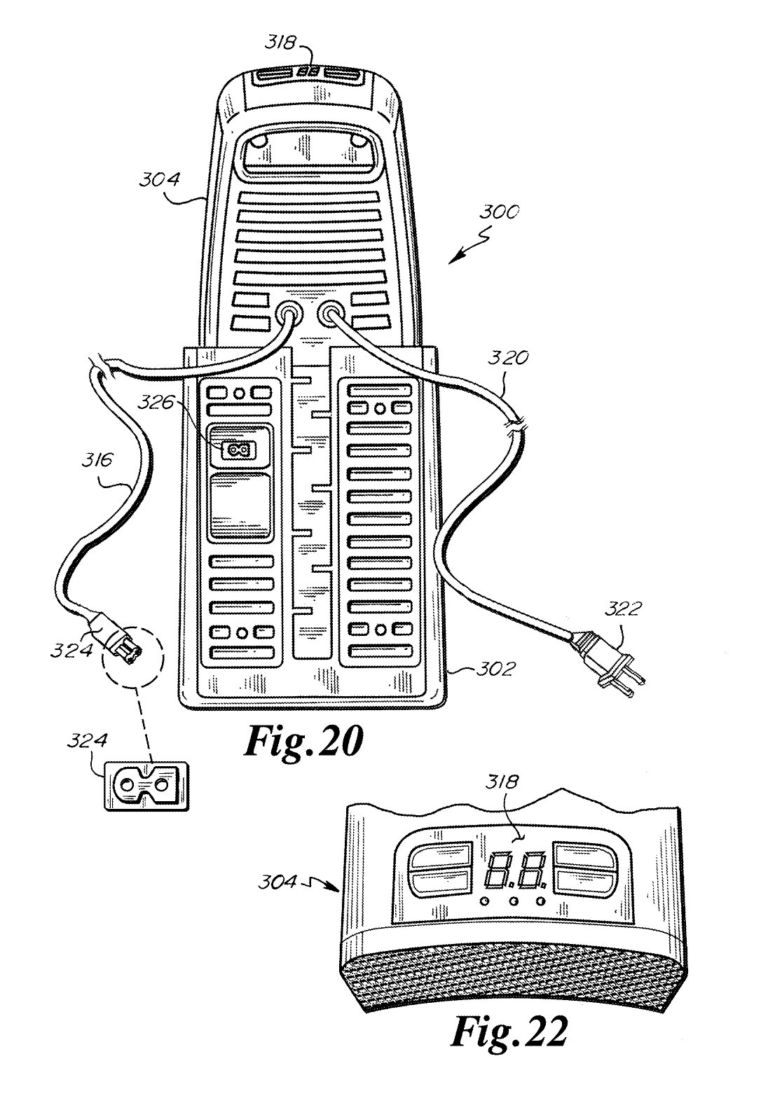

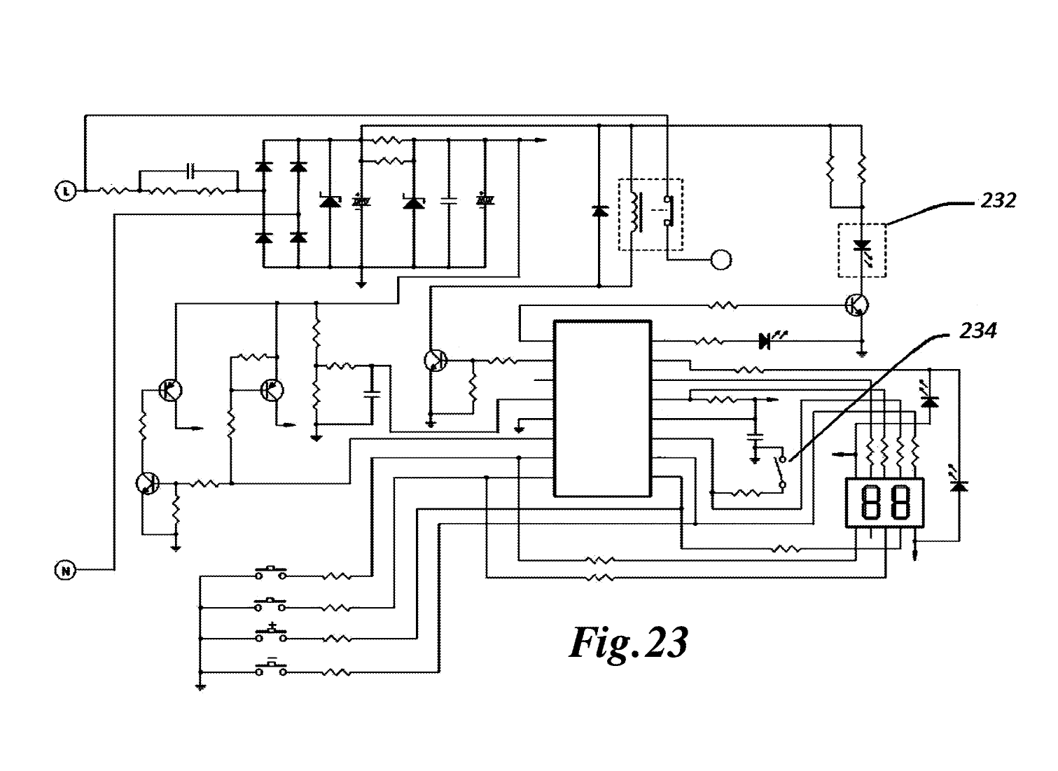

Referring next to FIGS. 19 through 22, a portable air heater 300 according to a third example of the invention is shown, which includes a slave-base unit 302 and a master-satellite unit 304. Structurally, this embodiment shares most of the features of the second embodiment, so that where structural features are not specifically shown of described, those may be assumed to be identical to the second embodiment. Electrically, this embodiment shares many of the features of the first embodiment, so that where electrical features are not specifically shown of described, those may be assumed to be identical to the first embodiment.

In this embodiment, only master-satellite unit 304 include controls; digital thermostatic and power controls 318, for managing the temperature and power output of both units, whether physically and electrically attached as in FIG. 19 or electrically attached through cord 316 but physically separated as in FIG. 21. Disconnectable cord 316 connects the two units and power to the master-satellite unit is derived through the slave-base unit's series-connected A/C cord 320 and A/C outlet 326.

A/C cord 320 is connectable to a standard NEMA 1 or NEMA 5 wall outlet by its NEMA 1 plug 322, to supply power to the slave-base unit and series-connected NEMA-1 or NEMA-5 A/C outlet 326. Disconnectable cord 316 includes a non NEMA 1 or NEMA 5 plug, in this case a polarized IEC320C7 plug 324, which is not connectable to a NEMA 1 or NEMA 5 wall outlet. Slave-base unit 302 has an IEC320C7 receptacle 326 to disconnectably receive this plug to allow the slave-base until to receive its power through the master-satellite unit 304. This safety feature prevents improper connection of the master-satellite unit to two sources of A/C power, prevents the improper use of a NEMA 1 or NEMA 5 extension cord to improperly energize the slave-base unit, and forces proper operation and control of the slave-base unit only through the master-satellite unit.

The disconnectability of cord 316 provides, among others, the advantage of allowing the cord to be snaked through tight spaces and reconnected so that the two heating units can be connected and operated across such tight spaces, as explained in regards to the previous embodiments.

Depending on the length of cord 116, the slave-satellite unit may be placed and operated remotely from the master-base unit and at a distance capable of serving two users or two portions of a room. The disclosed cord 116 is preferably six feet in length to allow operational separation of the heating unit approximately six feet. A male-to-female IEC320C7 extension cord may be employed to extend this separation distance. The disclosed heater 100 provides that when the two heating units are connected through the disconnectable cord, the controls 118 control operation of both heating units identically, with both operating at identical power outputs and operating only when the thermostat of the master-base unit is closed, thereby only and always both operating when the ambient temperature is below the selected thermostat setting. However, the slave-satellite unit may alternatively have a second and independent thermostat that allows it to operate according to a different ambient temperature sensed at its remote location.

While each of the heating units of the disclosed heater draw 750 Watts at all times operating, the master-satellite unit could alternatively include means to sense electrical disconnection of the slave-base unit and to increase its power to 1500 Watts when operating alone.

As another alternative, any of the afore-described heaters may be permanently wired together by a non-disconnectable cord, or may be connected by a cord, disconnectable or non-disconnectable that also provides electronic control signals between the units, either over additional wiring in the cord or by small signal communication between the two units over the cord's existing wires.

While the invention has been shown and described with reference to a specific exemplary embodiment, it should be understood by those skilled in the art that various changes may be made thereto without sacrificing its material advantages. Various changes in form and detail may be made without departing from the spirit and scope of the invention, and the invention should therefore only be limited according to the following claims, including all equivalent interpretation to which they are entitled.

I claim:

1. An electric heater comprising:
a master heating unit; and
a slave heating unit;
wherein the slave heating unit derives heating power and heating control from the master unit through a disconnectable electrical cord.

2. The electric heater of claim 1 wherein one of the master and slave units comprises a connector, and the other of the master and slave units comprises the disconnectable cord, and wherein the disconnectable cord is adapted to electrically and mechanically connect to and disconnect from the connector.

3. The electric heater of claim 2 wherein the connector is a non NEMA 1 or NEMA 5 outlet.

4. The electrical heater of claim 3 wherein the master and slave units are adapted for tool-free mechanical attachment and separation.

5. The electrical heater of claim 1 wherein the master and slave units are adapted for tool-free mechanical attachment and separation.

6. An electric heater comprising:
a satellite heating unit; and
a base heating unit;
wherein the base unit derives heating power and heating control from the satellite unit through a disconnectable electrical cord.

7. The electric heater of claim 6 wherein one of the satellite and base units comprises a connector, and the other of the satellite and base units comprises the disconnectable cord, and wherein the disconnectable cord is adapted to electrically and mechanically connect to and disconnect from the connector.

8. The electric heater of claim 7 wherein the connector is a non NEMA 1 or NEMA 5 outlet.

9. The electrical heater of claim 8 wherein the master and slave units are adapted for tool-free mechanical attachment and separation.

10. The electrical heater of claim 6 wherein the master and slave units are adapted for tool-free mechanical attachment and separation.

11. An electric heater comprising:
a satellite heating unit; and
a base heating unit;
wherein the base unit selectably derives heating power and heating control either from the satellite unit through a disconnectable electrical cord or derives heating power and heating control independently there-from.

12. The electric heater of claim 11 wherein one of the satellite and base units comprises a connector, and the other of the satellite and base units comprises the disconnectable cord, and wherein the disconnectable cord is adapted to electrically and mechanically connect to and disconnect from the connector.

13. The electric heater of claim 12 wherein the disconnectable cord is adapted to selectably connect to a NEMA 1 or NEMA 5 outlet to derive heating power there-from when disconnected from the connector.

14. The electrical heater of claim 13 wherein the master and slave units are adapted for tool-free mechanical attachment and separation.

15. The electrical heater of claim 11 wherein the master and slave units are adapted for tool-free mechanical attachment and separation.

16. The electric heater of claim 15 further comprising a communicating arrangement to distinguish between the attachment and the separation of the satellite and base units and alter the heating power and control according thereto.

17. The electric heater of claim 16 wherein the communicating arrangement causes transfer of at least some of the heating control of the base unit from the base unit to the satellite unit during the attachment of the satellite and base units.

18. The electronic heater of claim 16 wherein the communicating arrangement comprises one or more of a mechanical switch and an electronic photo-coupler.

19. An electric heater comprising:
a master heating unit; and
a slave heating unit;
wherein the slave unit selectably derives heating power and heating control either from the master unit through a disconnectable electrical cord or derives heating power and heating control independently there-from.

20. The electric heater of claim 19 wherein one of the master and slave units comprises a connector, and the other of the master and slave units comprises the disconnectable cord, and wherein the disconnectable cord is adapted to electrically and mechanically connect to and disconnect from the connector.

21. The electric heater of claim 20 wherein the disconnectable cord is adapted to selectably connect to a NEMA 1 or NEMA 5 outlet to derive heating power there-from when disconnected from the connector.

22. The electrical heater of claim 21 wherein the master and slave units are adapted for tool-free mechanical attachment and separation.

23. The electrical heater of claim 19 wherein the master and slave units are adapted for tool-free mechanical attachment and separation.

24. The electric heater of claim 23 further comprising a communicating arrangement to distinguish between the attachment and the separation of the master and slave units and alter the heating power and control according thereto.

25. The electric heater of claim 24 wherein the communicating arrangement causes transfer of at least some of the heating control of the slave unit from the slave unit to the master unit during the attachment of the master and slave units.

26. The electronic heater of claim 24 wherein the communicating arrangement comprises one or more of a mechanical switch and an electronic photo-coupler.
